(19) United States
(12) Patent Application Publication
(10) Pub. No.: US 2026/0111008 A1
(43) Pub. Date: Apr. 23, 2026

(54) COMMUNICATION SERVER INTEGRATION VIA CONTROL LAYER

(71) Applicant: Rockwell Automation Technologies, Inc., Mayfield Heights, OH (US)

(72) Inventors: Athreya KS, Bengaluru (IN); Nandu Krishnan, Bengaluru (IN)

(21) Appl. No.: 18/922,662

(22) Filed: Oct. 22, 2024

(51) Int. Cl. G05B 19/418

(52) U.S. Cl. CPC G05B 19/4186

(57) ABSTRACT

A system may include a server that may communicate via an Open Platform Communications United Architecture (OPC UA) protocol. The system may also include an input/output (I/O) device having a server component configured to communicate with the server via the OPC UA protocol and a pipeline component. The pipeline component may translate one or more datasets received by the I/O device into the OPC UA protocol and send the one or more translated datasets to the server via the server component.

### BACKGROUND

The present disclosure generally relates to tools for managing data communication across different communication protocols.

Industrial automation systems may be used to provide automated control of one or more actuators in an industrial setting. Operational Technology (OT) networks may be used to communicatively couple industrial automation systems and/or industrial automation components within an industrial automation system. Certain communication protocols may dictate access to and operation of OT assets within the OT network. Indeed, in some OT networks, there may be a number of divers communication protocols, which may make communications between assets in a diverse industrial setting challenging. Accordingly, techniques for implementing improved data communication techniques in the OT network may be useful.

This section is intended to introduce the reader to aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system may include a server that may communicate via an Open Platform Communications United Architecture (OPC UA) protocol. The system may also include an input/output (I/O) device having a server component configured to communicate with the server via the OPC UA protocol and a pipeline component. The pipeline component may translate one or more datasets received by the I/O device into the OPC UA protocol and send the one or more translated datasets to the server via the server component.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present embodiments will become better understood when the following detailed description is read with reference to the accompanying drawings in which like characters represent like parts throughout the drawings, wherein:

FIG. 1 is a schematic view of an industrial automation system, in accordance with embodiments presented herein;

FIG. 2 is a block diagram of example components that could be used in the industrial automation system of FIG. 1, in accordance with embodiments presented herein;

FIG. 3 is a perspective view of an example of the industrial automation system of FIG. 1 controlled by an industrial control system, in accordance with an embodiment;

FIG. 4 is a block diagram of an Open Platform Communications United Architecture (OPC UA) component and a pipeline component that may be part of an input/output (I/O) device, in accordance with embodiments presented herein;

FIG. 5 is a schematic diagram of different types of components that may be connected to each other via the OPC UA layer, in accordance with embodiments presented herein; and

FIG. 6 is a schematic diagram of individual I/O devices communicatively coupled together via the OPC UA layer, in accordance with embodiments presented herein; and

FIG. 7 is a schematic diagram of multiple I/O devices that are part of an edge device and communicatively coupled to each other via the OPC UA layer, in accordance with embodiments presented herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is related to implementing an Open Platform Communications United Architecture (OPC UA) layer in between input/output (I/O) devices of an industrial automation system. That is, each I/O device may communicate to other I/O devices via an OPC UA server component that may be part of the device itself or implemented via software executed on the device. In this way, any data communicated across the industrial automation system may be available on the OPC UA server. Accordingly, separate hardware devices are avoided to integrate different industrial device to an OPC UA server. Indeed, to enable the variety of I/O devices and industrial automation devices to communicate with each other, the I/O devices may also include a pipeline component that may perform certain protocol translation tasks and expose relevant data via an OPC UA server that is part of the respective device.

In this way, data that is available for communication via a controller may be requested by another I/O device without the logic for retrieving the relevant data being executed by a controller of the I/O device and the controller of the device storing the data. Instead, by providing the OPC UA server on each device, data may be stored on the OPC UA server and made available for other device via the OPC UA layer, thereby reducing the amount of time required to retrieve data.

By contrast, in other systems, a control system, such as a programmable logic controller (PLC), is employed to integrate with various I/O devices and interpret or translate the respective datasets received from those I/O devices. The control system may be connected to an edge device that may provide remote devices access to the I/O devices. As such, the control system may be a bottleneck for the datasets received from the I/O devices, and the edge device may be reliant on the control system to access any I/O devices. Further, the control system may be a security vulnerability with regard to accessing the I/O devices, since it is relied on for establishing communications with the I/O devices.

With this in mind, the I/O devices may include the OPC UA server component to establish an OPC UA layer into the industrial automation system. In this way, the datasets available to the I/O devices may be exposed to the OPC UA server layer, such that they may be available for access to any device via the OPC UA server layer. In some embodiments, the I/O devices may also include a functional block (e.g., software, hardware) that has an OPC UA mapping that enables the respective I/O devices to translate or convert data received via one protocol (e.g., Ethernet, MODBUS) into the OPC UA protocol.

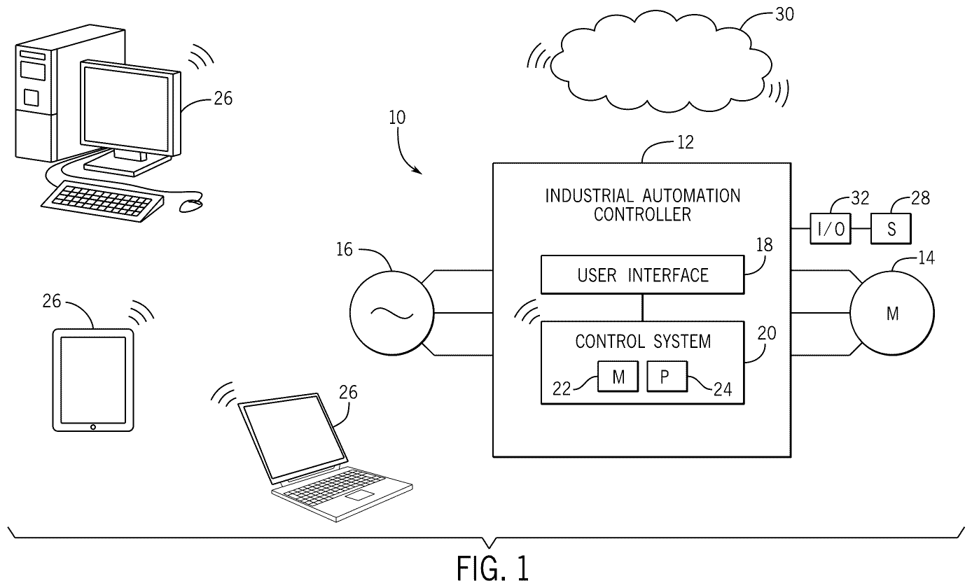

In addition, in some embodiments, the I/O devices may include compute surfaces that may perform certain processing operations, host applications, and the like. As such, the I/O devices may receive containerized applications to enable the respective devices to map received datasets to corresponding OPC UA datasets that may then be accessible to other devices via the OPC UA layer. Additional details with regard to the embodiments described above will be discussed below with reference to FIGS. 1-7.

By way of introduction, FIG. 1 is a schematic view of an example industrial automation system 10 in which the embodiments described herein may be implemented. As shown, the industrial automation system 10 includes a controller 12 and an actuator 14 (e.g., a motor). The industrial automation system 10 may also include, or be coupled to, a power source 16. The power source 16 may include a generator, an external power grid, a battery, or some other source of power. The controller 12 may be a stand-alone control unit that controls multiple industrial automation components (e.g., a plurality of motors 14), a controller 12 that controls the operation of a single automation component (e.g., motor 14), or a subcomponent within a larger industrial automation system 10. In the instant embodiment, the controller 12 includes a user interface 18, such as a human machine interface (HMI), and a control system 20, which may include a memory 22 and a processor 24. The controller 12 may include a cabinet or some other enclosure for housing various components of the industrial automation system 10, such as a motor starter, a disconnect switch, etc.

The control system 20 may be programmed (e.g., via computer readable code or instructions stored on the memory 22, such as a non-transitory computer readable medium, and executable by the processor 24) to provide signals for controlling the motor 14. In certain embodiments, the control system 20 may be programmed according to a specific configuration desired for a particular application. For example, the control system 20 may be programmed to respond to external inputs, such as reference signals, alarms, command/status signals, etc. The external inputs may originate from one or more relays or other electronic devices. The programming of the control system 20 may be accomplished through software or firmware code that may be loaded onto the internal memory 22 of the control system 20 (e.g., via a locally or remotely located computing device 26) or programmed via the user interface 18 of the controller 12. The control system 20 may respond to a set of operating parameters. The settings of the various operating parameters may determine the operating characteristics of the controller 12. For example, various operating parameters may determine the speed or torque of the motor 14 or may determine how the controller 12 responds to the various external inputs. As such, the operating parameters may be used to map control variables within the controller 12 or to control other devices communicatively coupled to the controller 12. These variables may include, for example, speed presets, feedback types and values, computational gains and variables, algorithm adjustments, status and feedback variables, programmable logic controller (PLC) control programming, and the like.

In some embodiments, the controller 12 may be communicatively coupled to one or more sensors 28 for detecting operating temperatures, voltages, currents, pressures, flow rates, and other measurable variables associated with the industrial automation system 10. With feedback data from the sensors 28, the control system 20 may keep detailed track of the various conditions under which the industrial automation system 10 may be operating. For example, the feedback data may include conditions such as actual motor speed, voltage, frequency, power quality, alarm conditions, etc. In some embodiments, the feedback data may be communicated back to the computing device 26 for additional analysis. The sensors 28 may be coupled to the controller 12 via one or more input/output (I/O) devices 32, which may collect datasets output by the sensors 28 and route them to the controller 12. As used herein, I/O devices 32 may facilitate communication between control systems (e.g., controller 12) and other equipment, such as sensors, machines, or processes being controlled.

The computing device 26 may be communicatively coupled to the controller 12 via a wired or wireless connection (e.g., via an edge device, gateway). The computing device 26 may receive inputs from a user defining an industrial automation project using a native application running on the computing device 26 or using a website accessible via a browser application, a software application, or the like. The user may define the industrial automation project by writing code, interacting with a visual programming interface, inputting or selecting values via a graphical user interface, or providing some other inputs. The user may use licensed software and/or subscription services to create, analyze, and otherwise develop the project. The computing device 26 may send a project to the controller 12 for execution. Execution of the industrial automation project causes the controller 12 to control components (e.g., motor 14) within the industrial automation system 10 through performance of one or more tasks and/or processes. In some applications, the controller 12 may be communicatively positioned in a private network and/or behind a firewall, such that the controller 12 does not have communication access outside a local network and is not in communication with any devices outside the firewall, other than the computing device 26. The controller 12 may collect feedback data during execution of the project, and the feedback data may be provided back to the computing device 26 for analysis. Feedback data may include, for example, one or more execution times, one or more alerts, one or more error messages, one or more alarm conditions, one or more temperatures, one or more pressures, one or more flow rates, one or more motor speeds, one or more voltages, one or more frequencies, and so forth. The project may be updated via the computing device 26 based on the analysis of the feedback data.

The computing device 26 may also send a project to the I/O device 32, which may include a computing component to execute the project. In any case, in some embodiments, the project may enable the respective device to receive datasets in one format or protocol and translate the datasets into an OPC UA (Open Platform Communications Unified Architecture) protocol. The OPC UA protocol may include a machine-to-machine communication protocol used in industrial automation for secure, reliable, and platform-independent data exchange between devices, machines, and control systems.

The computing device 26 may be communicatively coupled to a cloud server 30 or remote server via the internet, or some other network. In one embodiment, the cloud server 30 may be operated by the manufacturer of the controller 12, a software provider, a seller of the controller 12, a service provider, operator of the controller 12, owner of the controller 12, etc. The cloud server 30 may be used to help customers create and/or modify projects, to help troubleshoot any problems that may arise with the controller 12, develop policies, or to provide other services (e.g., project analysis, enabling, restricting capabilities of the controller 12, data analysis, controller firmware updates, etc.). The remote/cloud server 30 may be one or more servers operated by the manufacturer, software provider, seller, service provider, operator, or owner of the controller 12. The remote/cloud server 30 may be disposed at a facility owned and/or operated by the manufacturer, software provider, seller, service provider, operator, or owner of the controller 12. In other embodiments, the remote/cloud server 30 may be disposed in a datacenter in which the manufacturer, software provider, seller, service provider, operator, or owner of the controller 12 owns or rents server space. In further embodiments, the remote/cloud server 30 may include multiple servers operating in one or more data center to provide a cloud computing environment. For example, the remote/cloud server 30 may serve as a OPC UA server that is communicatively coupled to other OPC UA client devices, servers, or the like.

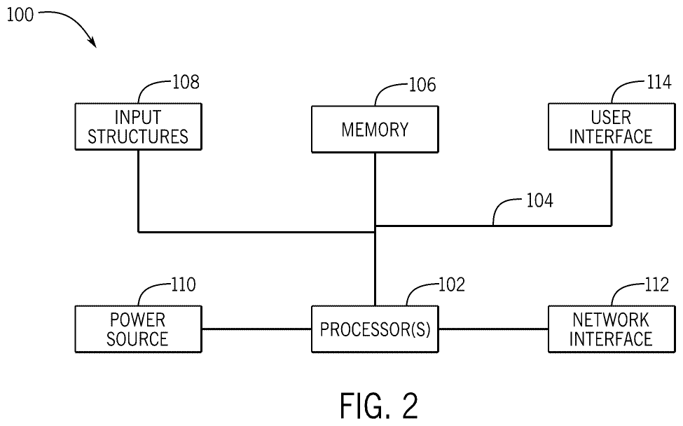

FIG. 2 illustrates a block diagram of example components of a computing device 100 that could be used as the computing device 26, the cloud/remote server 30, the controller 12, or some other device within the system 10 shown in FIG. 1. As used herein, a computing device 100 may be implemented as one or more computing systems including laptop, notebook, desktop, tablet, HMI, or workstation computers, as well as server type devices or portable, communication type devices, such as cellular telephones and/or other suitable computing devices.

As illustrated, the computing device 100 may include various hardware components, such as one or more processors 102, one or more busses 104, memory 106, input structures 108, a power source 110, a network interface 112, a user interface 114, and/or other computer components useful in performing the functions described herein.

The one or more processors 102 may include, in certain implementations, microprocessors configured to execute instructions stored in the memory 106 or other accessible locations. Alternatively, the one or more processors 102 may be implemented as application-specific integrated circuits (ASICs), field-programmable gate arrays (FPGAs), and/or other devices designed to perform functions discussed herein in a dedicated manner. As will be appreciated, multiple processors 102 or processing components may be used to perform functions discussed herein in a distributed or parallel manner.

The memory 106 may encompass any tangible, non-transitory medium for storing data or executable routines. Although shown for convenience as a single block in FIG. 2, the memory 106 may encompass various discrete media in the same or different physical locations. The one or more processors 102 may access data in the memory 106 via one or more busses 104.

The input structures 112 may allow a user to input data and/or commands to the device 100 and may include mice, touchpads, touchscreens, keyboards, controllers, and so forth. The power source 114 can be any suitable source for providing power to the various components of the computing device 100, including line and battery power. In the depicted example, the device 100 includes a network interface 116. Such a network interface 116 may allow communication with other devices on a network using one or more communication protocols. In the depicted example, the device 100 includes a user interface 118, such as a display that may display images or data provided by the one or more processors 102. The user interface 118 may include, for example, a monitor, a display, and so forth. As will be appreciated, in a real-world context a processor-based system, such as the computing device 100 of FIG. 2, may be employed to implement some or all of the present approach, such as performing the functions of the controller, the computing device 26, and/or the cloud/remote server 30 shown in FIG. 1, as well as other memory-containing devices.

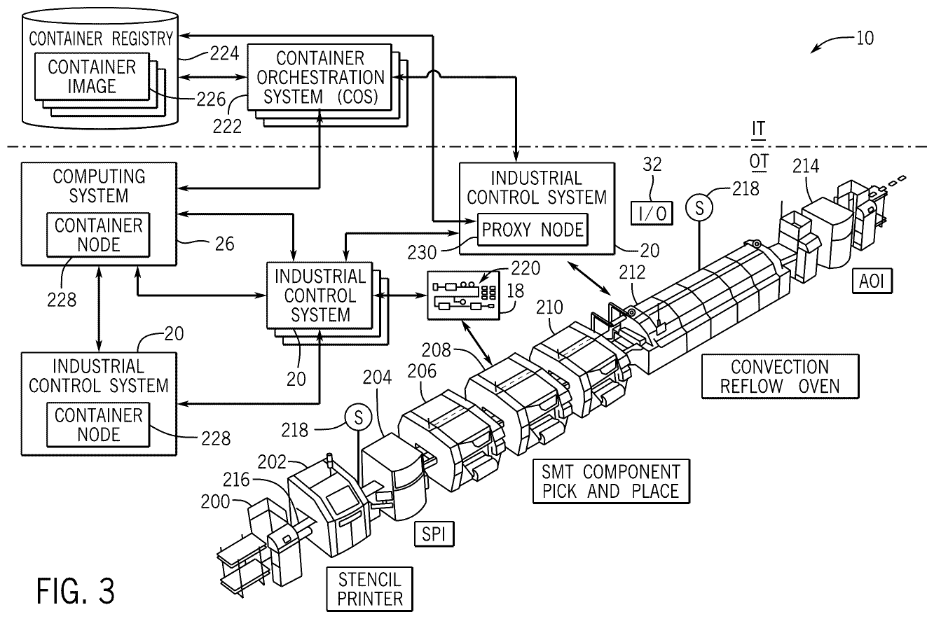

FIG. 3 is a perspective view of an example of the industrial automation system 10 of FIG. 1. The industrial automation system 10 includes stations 200, 202, 204, 206, 208, 210, 212, 214 having machine components and/or machines to conduct functions within an automated process, such as silicon wafer manufacturing, as is depicted. The automated process may begin at a station 200 used for loading objects, such as substrates, into the industrial automation system 10 via a conveyor section 216. For example, objects may be transported along the conveyor section 216 to station 202 to perform a first action, such a printing solder paste to the substrate via stenciling. As objects exit from the station 202, the objects may be transported via the conveyor section 216 to a station 204 for solder paste inspection (SPI) to inspect printer results, to a station 206, 208, and 210 for surface mount technology (SMT) component placement, to a station 212 for convection reflow oven to melt the solder to make electrical couplings, and finally to a station 214 for automated optical inspection (AOI) to inspect the object manufactured (e.g., the manufactured printed circuit board). After the objects proceed through the various stations, the objects may be removed from the station 14H, for example, for storage in a warehouse or for shipment. It should be understood, however, that for other applications, the particular system, machine components, machines, stations, and/or conveyors may be different or specially adapted to the application.

For example, the industrial automation system 10 may include machinery to perform various operations in a compressor station, an oil refinery, a batch operation for making food items, chemical processing operations, brewery operations, mining operations, a mechanized assembly line, and so forth. Accordingly, the industrial automation system 10 may include a variety of operational components, such as electric motors, valves, actuators, temperature elements, pressure sensors, or a myriad of machinery or devices used for manufacturing, processing, material handling, and other applications. The industrial automation system 10 may also include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation system 10 may also include motors, protection devices, switchgear, compressors, and the like. Each of these described operational components may correspond to and/or generate a variety of operational technology (OT) data regarding operation, status, sensor data, operational modes, alarm conditions, or the like, that may be desirable to output for analysis with IT data from an IT network, for storage in an IT network, for analysis with expected operation set points (e.g., thresholds), or the like.

In certain embodiments, one or more properties of the industrial automation system 10 equipment, such as the stations 200, 202, 204, 206, 208, 210, 212, 214, may be monitored and controlled by the industrial control systems 20 for regulating control variables. For example, sensing devices (e.g., sensors 218) may monitor various properties of the industrial automation system 10 and may be used by the industrial control systems 20 at least in part in adjusting operations of the industrial automation system 10 (e.g., as part of a control loop). In some cases, the industrial automation system 10 may be associated with devices used by other equipment. For instance, scanners, gauges, valves, flow meters, and the like may be disposed on or within the industrial automation system 10. Here, the industrial control systems 20 may receive data from the associated devices and use the data to perform their respective operations more efficiently. For example, a controller of the industrial automation system 10 associated with a motor drive may receive data regarding a temperature of a connected motor and may adjust operations of the motor drive based on the data.

The industrial control systems 20 may include or be communicatively coupled to the display/operator interface 18 (e.g., a human-machine interface (HMI)) and to devices of the industrial automation system 10. It should be understood that any suitable number of industrial control systems 20 may be used in a particular industrial automation system 10 embodiment. The industrial control systems 20 may facilitate representing components of the industrial automation system 10 through programming objects that may be instantiated and executed to provide simulated functionality similar or identical to the actual components, as well as visualization of the components, or both, on the display/operator interface 18. The programming objects may include code and/or instructions stored in the industrial control systems 20 and executed by processing circuitry of the industrial control systems 20. The processing circuitry may communicate with memory circuitry to permit the storage of the component visualizations. The programming objects may also be deployed to various devices, such as the I/O devices 32 and the like, to perform embodiments described herein.

As illustrated, a display/operator interface 18 may depict representations 220 of the components of the industrial automation system 10. The industrial control system 20 may use data transmitted by the sensors 218 to update visualizations of the components via changing one or more statuses, states, and/or indications of current operations of the components. These sensors 218 may be any suitable device adapted to provide information regarding process conditions. Indeed, the sensors 218 may be used in a process loop (e.g., control loop) that may be monitored and controlled by the industrial control system 20. As mentioned above, the sensors 218 may be coupled to the control system 20 via the I/O devices 32. Each I/O device 32 may receive datasets from the sensors 218 according to different frequencies, different protocols, different formats, and the like.

In any case, a process loop may be activated based on process inputs (e.g., an input from the sensor 218) or direct input from a person via the display/operator interface 18. The person operating and/or monitoring the industrial automation system 10 may reference the display/operator interface 18 to determine various statuses, states, and/or current operations of the industrial automation system 10 and/or for a particular component. Furthermore, the person operating and/or monitoring the industrial automation system 10 may adjust to various components to start, stop, power-down, power-on, or otherwise adjust an operation of one or more components of the industrial automation system 10 through interactions with control panels or various input devices.

The industrial automation system 10 may be considered a data-rich environment with several processes and operations that each respectively generate a variety of data. For example, the industrial automation system 10 may be associated with material data (e.g., data corresponding to substrate or raw material properties or characteristics), parametric data (e.g., data corresponding to machine and/or station performance, such as during operation of the industrial automation system 10), test results data (e.g., data corresponding to various quality control tests performed on a final or intermediate product of the industrial automation system 10), or the like, that may be organized and sorted as OT data. In addition, the sensors 218 may gather OT data indicative of one or more operations of the industrial automation system 10 or the industrial control system 20. In this way, the OT data may be analog data or digital data indicative of measurements, statuses, alarms, or the like associated with operation of the industrial automation system 10 or the industrial control system 20.

The industrial control systems 12 described above may operate in an OT space in which OT data is used to monitor and control OT assets, such as the equipment illustrated in the stations 200, 202, 204, 206, 208, 210, 212, 214 of the industrial automation system 10 or other industrial equipment. The OT space, environment, or network generally includes direct monitoring and control operations that are coordinated by the industrial control system 20 and a corresponding OT asset. For example, a programmable logic controller (PLC) may operate in the OT network to control operations of an OT asset (e.g., drive, motor, and/or high-level controllers). The industrial control systems 20 may be specifically programmed or configured to communicate directly with the respective OT assets.

A container orchestration system 222, on the other hand, may operate in an information technology (IT) environment. That is, the container orchestration system 222 may include a cluster of multiple computing devices that coordinates an automatic process of managing or scheduling work of individual containers for applications within the computing devices of the cluster. In other words, the container orchestration system 222 may be used to automate various tasks at scale across multiple computing devices. By way of example, the container orchestration system 222 may automate tasks such as configuring and scheduling deployment of containers, provisioning and deploying containers, determining availability of containers, configuring applications in terms of the containers that they run in, scaling of containers to equally balance application workloads across an infrastructure, allocating resources between containers, performing load balancing, traffic routing, and service discovery of containers, performing health monitoring of containers, securing the interactions between containers, and the like. In any case, the container orchestration system 222 may use configuration files to determine a network protocol to facilitate communication between containers, a storage location to save logs, and the like. The container orchestration system 222 may also schedule deployment of containers into clusters and identify a host (e.g., node) that may be best suited for executing the container. After the host is identified, the container orchestration system 222 may manage the lifecycle of the container based on predetermined specifications.

With the foregoing in mind, it should be noted that containers refer to technology for packaging an application along with its runtime dependencies. That is, containers include applications that are decoupled from an underlying host infrastructure (e.g., operating system). By including the run time dependencies with the container, the container may perform in the same manner regardless of the host in which it is operating. In some embodiments, containers may be stored in a container registry 224 as container images 226. The container registry 224 may be any suitable data storage or database that may be accessible to the container orchestration system 222. The container image 226 may correspond to an executable software package that includes the tools and data employed to execute a respective application. That is, the container image 226 may include related code for operating the application, application libraries, system libraries, runtime tools, default values for various settings, and the like.

By way of example, an integrated development environment (IDE) tool may be employed by a user to create a deployment configuration file that specifies a desired state for the collection of nodes of the container orchestration system 222. The deployment configuration file may be stored in the container registry 224 along with the respective container images 226 associated with the deployment configuration file. The deployment configuration file may include a list of different pods and a number of replicas for each pod that should be operating within the container orchestration system 222 at any given time. Each pod may correspond to a logical unit of an application, which may be associated with one or more containers. The container orchestration system 222 may coordinate the distribution and execution of the pods listed in the deployment configuration file, such that the desired state is continuously met. In some embodiments, the container orchestration system 222 may include a master node that retrieves the deployment configuration files from the container registry 224, schedules the deployment of pods to the connected nodes, and ensures that the desired state specified in the deployment configuration file is met. For instance, if a pod stops operating on one node, the master node may receive a notification from the respective worker node that is no longer executing the pod and deploy the pod to another worker node to ensure that the desired state is present across the cluster of nodes.

As mentioned above, the container orchestration system 222 may include a cluster of computing devices, computing systems, or container nodes that may work together to achieve certain specifications or states, as designated in the respective container. In some embodiments, container nodes 228 may be integrated within industrial control systems 20 as shown in FIG. 3. That is, container nodes 228 may be implemented by the industrial control systems 20, such that they appear as worker nodes to the master node in the container orchestration system 222. In this way, the master node of the container orchestration system 222 may send commands to the container nodes 228 that are also configured to perform applications and operations for the respective industrial equipment.

With this in mind, the container nodes 228 may be integrated with the industrial control systems 20, such that they serve as passive-indirect participants, passive-direct participants, or active participants of the container orchestration system 222. As passive-indirect participants, the container nodes 228 may respond to a subset of all of the commands that may be issued by the container orchestration system 222. In this way, the container nodes 228 may support limited container lifecycle features, such as receiving pods, executing the pods, updating a respective filesystem to included software packages for execution by the industrial control system 20, and reporting the status of the pods to the master node of the container orchestration system 222. The limited features implementable by the container nodes 228 that operate in the passive-indirect mode may be limited to commands that the respective industrial control system 20 may implement using native commands that map directly to the commands received by the master node of the container orchestration system 222. Moreover, the container node 228 operating in the passive-indirect mode of operation may not be capable to push the packages or directly control the operation of the industrial control system 20 to execute the package. Instead, the industrial control system 20 may periodically check the file system of the container node 228 and retrieve the new package at that time for execution.

As passive-direct participants, the container nodes 228 may operate as a node that is part of the cluster of nodes for the container orchestration system 222. As such, the container node 228 may support the full container lifecycle features. That is, container node 228 operating in the passive-direct mode may unpack a container image and push the resultant package to the industrial control system 20, such that the industrial control system 20 executes the package in response to receiving it from the container node 228. As such, the container orchestration system 222 may have access to a worker node that may directly implement commands received from the master node onto the industrial control system 20.

In the active participant mode, the container node 228 may include a computing module or system that hosts an operating system (e.g., Linux) that may continuously operate a container host daemon that may participate in the management of container operations. As such, the active participant container node 228 may perform any operations that the master node of the container orchestration system 222 may perform. By including a container node 228 operating in the OT space, the container orchestration system 222 is capable of extending its management operations into the OT space. That is, the container node 228 may provision devices in the OT space, serve as a proxy node 230 to provide bi-directional coordination between the IT space and the OT space, and the like. For instance, the container node 228 operating as the proxy node 230 may intercept orchestration commands and cause industrial control system 20 to implement appropriate machine control routines based on the commands. The industrial control system 20 may confirm the machine state to the proxy node 230, which may then reply to the master node of the container orchestration system 222 on behalf of the industrial control system 20.

Additionally, the industrial control system 20 may share an OT device tree via the proxy node 230. As such, the proxy node 230 may provide the master node with state data, address data, descriptive metadata, versioning data, certificate data, key information, and other relevant parameters concerning the industrial control system 20. Moreover, the proxy node 230 may issue requests targeted to other industrial control systems 20 to control other OT devices. For instance, the proxy node 230 may translate and forward commands to a target OT device using one or more OT communication protocols, may translate and receive replies from the OT devices, and the like. As such, the proxy node 230 may perform health checks, provide configuration updates, send firmware patches, execute key refreshes, and other OT operations for other OT devices.

Keeping the forgoing in mind, the OT space may involve communications that are formatted according to OT communication protocols, such as FactoryTalk LiveData, EtherNet/IP. Common Industrial Protocol (CIP), OPC Direct Access (e.g., machine to machine communication protocol for industrial automation developed by the OPC Foundation), OPC Unified Architecture (OPC UA), or any suitable OT communication protocol (e.g. DNP3, Modbus, Profibus, LonWorks, DALI, BACnet, KNX, EnOcean). Because the industrial control systems 20 operate in the OT space via a variety of communication protocols, the industrial control systems may not be capable of implementing commands received from each other.

By way of example, the OT devices of the industrial automation system may correspond to an industrial automation device or component. The OT device may include any suitable industrial device that operates in the OT space. As such, the OT device may be involved in adjusting physical processes being implemented via the industrial system 10. In some embodiments, the OT device may include motor control centers, motors, HMIs, operator interfaces, contactors, starters, sensors, drives, relays, protection devices, switchgear, compressors, network switches (e.g., Ethernet switches, modular-managed, fixed-managed, service-router, industrial, unmanaged, etc.), I/O devices 32, and the like. In addition, the OT device may also be related to various industrial equipment such as mixers, machine conveyors, tanks, skids, specialized original equipment manufacturer machines, and the like. The OT device may also be associated with devices used by the equipment such as scanners, gauges, valves, flow meters, and the like.

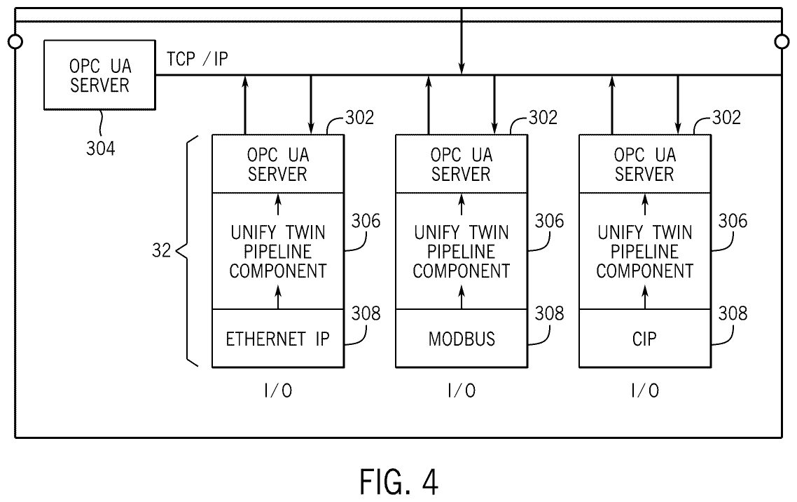

Referring now to FIG. 4, in some embodiments, the input/output (I/O) devices 32 that may enable control systems 20 to communicate with industrial devices (e.g., OT devices) may include an OPC UA server component 302, a pipeline component 306, and a network interface component 308. As mentioned above, the I/O device 32 may enable communication between the control system 20 (e.g., PLC) and the external devices like sensors, actuators, and other peripherals. As such, the I/O devices 32 may operate as a bridge communication layer between a controller and the physical world, enabling the system to collect data (inputs) and send control signals (outputs).

The OPC UA server component 302 may operate as a node that interfaces with an OPC UA server 304. That is, the OPC UA server 304 may coordinate communication from OPC UA server components 302 to facilitate a uniform communication protocol between the I/O devices 32. In addition, the OPC server components 302 may form an OPC UA layer that enables OPC UA communications to be transmitted directly to I/O devices 32 and other devices with the OPC UA server component 302. The OPC UA (Open Platform Communications Unified Architecture) protocol may include a machine-to-machine communication protocol that enables secure and reliable data exchange between devices, systems, and services, within industrial automation system.

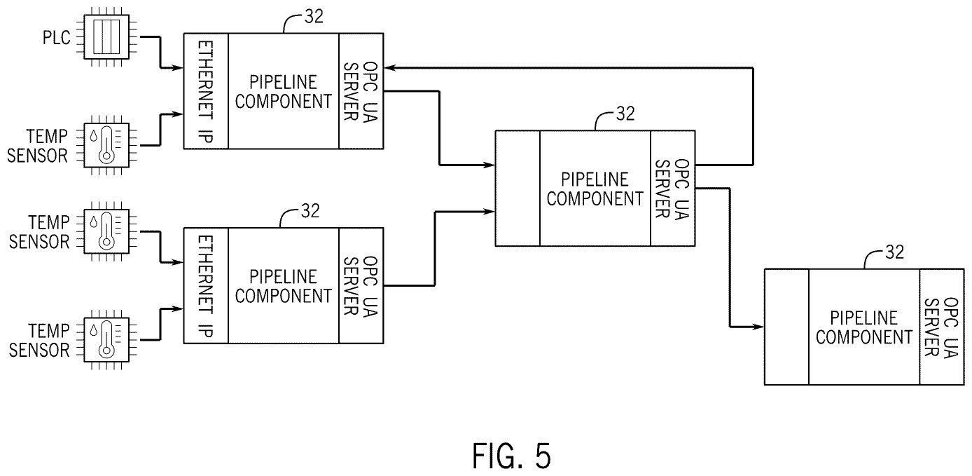

To enable OPC UA communications to access other components, the pipeline component 306 may perform various translation or protocol conversion operations. As shown in FIG. 4, the I/O devices 32 depicted in FIG. 4 may communicate via Ethernet IP, Modbus, and CIP. In this way, the pipeline component 306 may translate OPC UA communications received via the OPC UA server component into the respective protocols for Ethernet IP, Modbus, and CIP, and vice-versa. As a result, various sensors and components, as depicted in FIG. 5, may be accessible to different I/O devices 32 in the industrial automation system 10.

Referring to FIG. 5, different I/O devices 32 may be coupled to each other via an OPC UA layer to facilitate device-to-device communication. As such, the collection of I/O devices 32 may form an OPC UA layer that enables communication with each other without intervening via the control system 20 or other suitable device. In some embodiments, the pipeline component 306 may be implemented via a computing system or other suitable processing system. As such, the pipeline component 306 may be programmed using a project, code, programming objects, containers, or the like. As such, the control system 20, the container orchestration system 22, or the like may receive inputs from a user that specify the OPC UA mappings that may be implemented on the respective I/O device 32. That is, the I/O device 32 may include a number of input pins or ports that may be designated to be coupled to different components that may use different communication protocols. As such, the user may send an application or container to the I/O device 32 to cause the pipeline component 306 or other suitable device to designate certain input ports as being associated with a particular protocol and a corresponding OPC UA mapping that translates the received input data into one or more OPC UA communication packets.

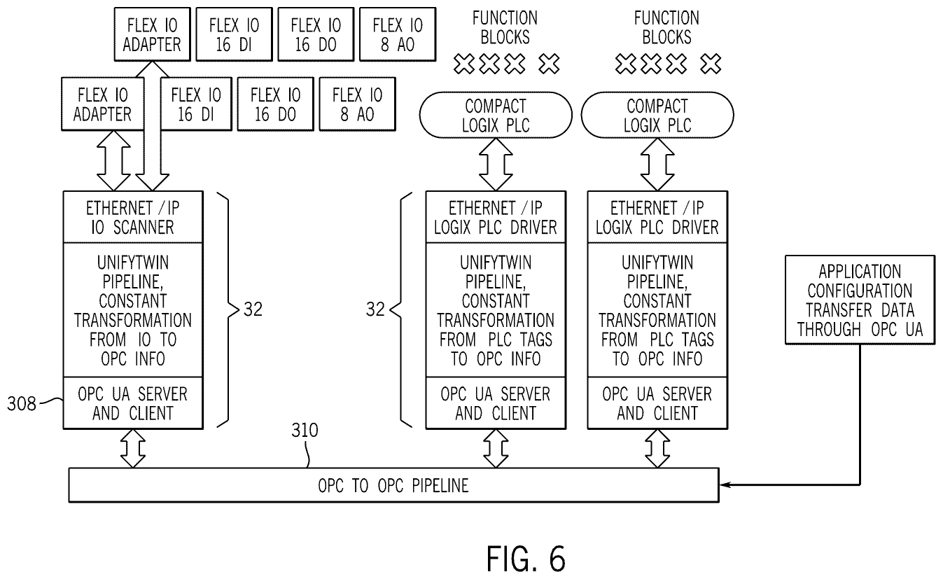

With the foregoing in mind, in some embodiments, multiple I/O devices 32 may each individually connect to an OPC UA pipeline 310 as shown in FIG. 6 to enable scaling of communication component. As such, the I/O devices 32 may be directly coupled to each other via the OPC UA server component 308. In addition, the I/O devices 32 may receive application configuration data, containers, and other configuration parameters that may be provided by the control system 20, the container orchestration system 22, or the like via the OPC UA pipeline 310.

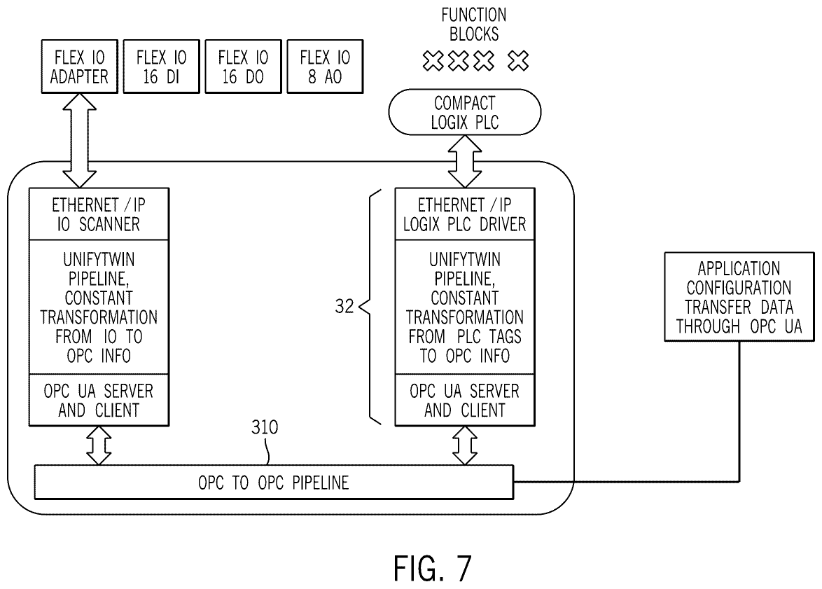

In some embodiments, the different I/O devices may also be integrated into an edge device, as depicted in FIG. 7. In this case, the edge device may include the OPC UA pipeline 310 to connect different I/O devices 32. As such, the edge device may include a number of input ports that may be specified or designated for certain functional blocks via software implemented using computing resources of the edge device. That is, the edge device may include a processing system or the like to perform operations of the I/O device 32 via the processing system based on application configuration data, containers, and other configuration parameters that may be provided by the control system 20, the container orchestration system 22, or the like.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . .” or “step for [perform]ing [a function] . . .”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a server configured to communicate via an Open Platform Communications United Architecture (OPC UA) protocol; and
an input/output (I/O) device comprising:
a server component configured to communicate with the server via the OPC UA protocol;
a pipeline component configured to:
translate one or more datasets received by the I/O device into the OPC UA protocol; and
send the one or more translated datasets to the server via the server component.

2. The system of claim 1, wherein the one or more datasets are received via an operational technology (OT) protocol.

3. The system of claim 2, wherein the OT protocol comprises Modbus, EthernetIP, Profibus, Common Industrial Protocol (CIP), or any combination thereof.

4. The system of claim 1, comprising an additional I/O device configured to communicate with the I/O device via an OPC UA layer using the server component.

5. The system of claim 1, wherein one or more ports of the I/O device is defined by a user input comprising one or more OPC UA mappings to the one or more ports, wherein the one or more OPC UA mappings corresponds to one or more communication protocols.

6. The system of claim 1, comprising an edge device configured to host the I/O device.

7. The system of claim 1, wherein the one or more datasets comprise application configuration data.

8. The system of claim 1, comprising a container orchestration system configured to send one or more containers to the I/O device.

9. A non-transitory computer-readable medium comprising computer-executable instructions that, when executed, are configured to cause a processing system to perform operations comprising:
receiving one or more datasets via a first communication protocol;
translating the one or more datasets from the first communication protocol into an Open Platform Communications United Architecture (OPC UA) protocol; and
sending the one or more translated datasets to an OPC UA server component part of an input/output device.

10. The non-transitory computer-readable medium of claim 9, wherein the first communication protocol corresponds to an operational technology (OT) protocol.

11. The non-transitory computer-readable medium of claim 10, wherein the OT protocol comprises Modbus, EthernetIP, Profibus, Common Industrial Protocol (CIP), or any combination thereof.

12. The non-transitory computer-readable medium of claim 11, wherein one or more ports of the I/O device is defined by a user input comprising one or more OPC UA mappings to the one or more ports, wherein the one or more OPC UA mappings corresponds to one or more communication protocols.

13. The non-transitory computer-readable medium of claim 9, wherein the one or more datasets comprise application configuration data.

14. An input/output (I/O) device, comprising:
a server component configured to communicate with a server via Open Platform Communications United Architecture (OPC UA) protocol;
a pipeline component configured to:
translate one or more datasets received by the I/O device into the OPC UA protocol; and
send the one or more translated datasets to the server via the server component.

15. The I/O device of claim 14, wherein the one or more datasets are received via an operational technology (OT) protocol.

16. The I/O device of claim 15, wherein the OT protocol comprises Modbus, EthernetIP, Profibus, Common Industrial Protocol (CIP), or any combination thereof.

17. The I/O device of claim 14, wherein the server component is configured to send the one or more translated datasets to an additional I/O device configured to communicate with the I/O device via an OPC UA layer.

18. The I/O device of claim 14, wherein one or more ports of the I/O device is defined by a user input comprising one or more OPC UA mappings to the one or more ports, wherein the one or more OPC UA mappings corresponds to one or more communication protocols.

19. The I/O device of claim 14, wherein the one or more datasets comprise application configuration data.

20. The I/O device of claim 14, wherein the one or more datasets are received from a container orchestration system.
